(19) United States
(12) Patent Application Publication
(10) Pub. No.: US 2008/0044543 A1
(43) Pub. Date: Feb. 21, 2008

(54) Stabilized emulsions, methods of preparation, and related reduced fat foods

(76) Inventors: David Julian McClements, Northampton, MA (US); Eric Andrew Decker, Sunderland, MA (US); Jochen Weiss, South Hadley, MA (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/893,727

(22) Filed: Aug. 17, 2007

Related U.S. Application Data
(60) Provisional application No. 60/838,500, filed on Aug. 17, 2006.

(51) Int. Cl. A23L 1/035; B01F 3/08

(52) U.S. Cl. 426/573; 516/53; 516/54; 516/67; 516/72

(57) ABSTRACT

Emulsion compositions and related methods as can be used to improve food products and/or reduce the fat content thereof.

This application claims priority benefit from provisional application Ser. No. 60/838,500 filed on Aug. 17, 2006, the entirety of which is incorporated herein by reference.

The United States Government has certain rights to this invention pursuant to Grant No. 2005-35503-16164 from the United States Department of Agriculture to the University of Massachusetts.

### BACKGROUND OF THE INVENTION

It is well established that over-consumption of fats and oils leads to a variety of human health problems, including obesity, cardiovascular disease, hypertension and cancer. For example, the prevalence of obesity in the United States has increased by over 30% during the past decade. These diseases cause a major deterioration in the quality of life of the individuals involved, as well as putting a large economic burden on society as a whole. Consequently, there has been a major drive to educate people about the health risks associated with over-consumption of fats and oils, with the aim of reducing the proportion of calories obtained from fat.

The food industry has responded to this major health problem by developing and promoting reduced fat, low-fat or fat-free versions of many fatty food products. The manufacture of fat-reduced products is now a major sector of the food industry. Nevertheless, many consumers do not incorporate fat-reduced products into their diets because of the undesirable quality attributes often associated with this kind of product. There is therefore an urgent need to develop fat-reduced products that have quality attributes that are more desirable to consumers. A wide variety of different technologies have previously been developed: including fat substitutes (e.g., Olestra™), low-calorie fats (e.g., Salatrim™, Caprenin™), fat mimetics (e.g., maltodextrin, biopolymers, Simplesse™) and fat extenders. Each technology is associated with one or more well-documented disadvantages.

An alternate approach involves utilization of gelled biopolymer particles in double emulsions (sometimes called “multiple emulsions”) for producing reduced fat food emulsions and release systems. Water-in-oil-in-water (W/O/W) systems, for instance, have been known to the food industry for many years. As employed in a food product, the water component of such a system occupies a volume otherwise taken by a fat or oil, thereby reducing the amount of oil/fat in the food. A major advantage of W/O/W emulsions is that they can be produced with the same desirable appearance, texture, mouth feel and flavor as conventional O/W emulsions, but with a much reduced overall fat content. Further, (W/O/W) emulsions can, as compared to conventional systems, provide improved controlled/triggered release and protection of labile ingredients. Nevertheless, their utilization in foods has been severely restricted because of their relatively short shelf-life and their poor stability with regard to common food processing operations (such as mechanical agitation, thermal processing or freezing).

Water-in-oil-in-water (W/O/W) emulsions of the art typically consist of small water droplets trapped within larger oil droplets, which are dispersed within an aqueous continuous phase. Double emulsions, for instance, are normally prepared using a two-step procedure, using conventional homogenization technology (FIG. 1). First, a water-in-oil (W/O) emulsion is formed by blending a water phase and an oil phase together in the presence of a suitable oil-soluble (e.g., low hydrophile-lipophile balance, HLB, number) emulsifier. This emulsifier adsorbs to the surface of the water droplets and forms a protective coating that prevents their subsequent aggregation. Second, a water-in-oil-in-water (W/O/W) emulsion is then formed by homogenizing the W/O emulsion with another aqueous phase containing a suitable water-soluble (e.g., high HLB number) emulsifier. This emulsifier adsorbs to the surface of the oil droplets and forms a protective coating that prevents their subsequent aggregation.

Numerous research papers and review articles have been published, highlighting the potential of double emulsions for improving food product quality or functional properties. However, despite this potential, no double emulsion-based food products are believed to be currently present in the marketplace. One reason may be that double emulsions are highly susceptible to breakdown during storage or when exposed to environmental stresses common in the food industry, such stresses as may arise via mechanical forces, thermal processing, freezing or drying. A variety of instability mechanisms are believed responsible for W/O/W emulsion breakdown, with some of these being similar to those operating in conventional O/W emulsions and some being unique to double emulsions. The oil droplets in W/O/W emulsions are susceptible to creaming, flocculation, coalescence and Ostwald ripening just as they are in O/W emulsions. The inner water droplets in W/O/W emulsions are also susceptible to conventional flocculation, coalescence and Ostwald ripening processes, however, they may also become unstable due to diffusion of water molecules between the inner and outer aqueous phases or due to the expulsion of water droplets out of the oil droplets (See, e.g., FIG. 2).

Different strategies have been developed in an attempt to overcome the problems associated with the preparation of stable W/O/W emulsions, including: a combination of emulsifiers; incorporation of biopolymers at an oil-water interface; solidification of the oil phase; and balance of the osmotic pressures, to list but a few. However, many such strategies are not suitable for the food industry because of expense, use of non-food grade ingredients, or because of difficulties associated with large scale implementation, i.e., in food processing factories. As a result, the search for an effective, efficient and practical approach to multiple emulsions remains an ongoing concern in the art.

### SUMMARY OF THE INVENTION

In light of the foregoing, it is an object of the present invention to provide multi-phase emulsions, related compositions and/or method(s) for their preparation and/or use in reduced fat food products, thereby overcoming various deficiencies and shortcomings of the prior art, including those outlined above. It will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It is an object of the present invention to provide a W/O/W double emulsion with an internal aqueous phase stable during periods of prolonged storage. It can be a related object to provide such an emulsion with a hydrophobic/lipid phase stable to creaming, flocculation, coalescence and/or Ostwald ripening.

It can be another object of the present invention to provide a W/O/W double emulsion resistant to stresses induced during production, storage, transport, and/or food product utilization, such stresses including but not limited to mechanical agitation and environmental heating, chilling, freezing and/or drying.

It can be another object of the present invention to provide one or more such emulsions, phases and/or components thereof, methods for their preparation and/or related food products imparting desired appropriate rheology, appearance and/or flavor characteristics.

It can be another object of this invention, alone or in conjunction with any of the preceding objectives, to provide such emulsions and/or methods for their preparation utilizing cost-effective food grade components or ingredients for facile implementation into current food processing lines without undue regulatory concerns.

Other objects, features, benefits and advantages of the present invention will be apparent from the summary and the following descriptions of certain embodiments, and will be readily apparent to those skilled in the art having knowledge of various emulsion systems, compositions and methods for their preparation and use. Such objects, features, benefits and advantages will be apparent from the above as taken into conjunction with the accompanying examples, data, figures and all reasonable inferences to be drawn therefrom, alone or with consideration of the references incorporated herein.

In part, the present invention can relate to a multi-phase emulsion composition. Such a composition can comprise a first aqueous phase comprising a biopolymeric gelling component; a substantially hydrophobic phase about or encompassing the first aqueous phase, the hydrophobic phase comprising a lipid component; and a second aqueous phase about or encompassing the hydrophobic phase. In certain embodiments, the gelling component can be at least partially soluble in the first aqueous phase. In certain other embodiments, the first aqueous phase can comprise a gel in conjunction with such a component, such a component as can be at least partially gelled within and/or throughout the first aqueous phase.

Such compositions can comprise one or more food grade gelling components known in the art capable of sol-gel transition. Such biopolymeric gelling components can include but are not limited to any one or more dairy proteins, vegetable proteins, meat proteins, fish proteins, plant proteins, ovalbumins, glycoproteins, mucoproteins, phosphoproteins, serum albumins, collagen, phospholipids such as but not limited to soy, egg and milk lecithins, polysaccharides such as but not limited to, chitosan, pectin, gums (e.g., locust bean gum, gum arabic, guar gum, gum acacia, gellan gum, tragacanth gum, karaya gum, konjac gum, seed gums and xanthan gum), alginic acids, alginates and derivatives thereof, carrageenans, starches, modified starches (e.g., carboxymethyl dextran, etc.), cellulose and modified celluloses (e.g., carboxymethyl cellulose, etc.). Regardless of component(s) identity, quantities useful in conjunction with this invention can be, depending on the relative first aqueous phase volume, sufficient to achieve the desired degree of gellation and/or mechanical/physical properties for a given end-use application, such quantities as would be understood by those skilled in the art made aware of this invention.

Regardless of gelling component and/or aqueous phase composition, the hydrophobic phase can comprise a lipid component as would be understood by those skilled in the art. Without limitation, such a component can comprise an oil, fat and any combination thereof. The terms lipid phase, lipid component, oil phase, oil component, fat phase and fat component are used interchangeably, herein. Accordingly, the hydrophobic phase can be at least partially insoluble in an aqueous medium and/or is capable of forming an emulsion in an aqueous medium. The hydrophobic phase can comprise a fat or an oil component, including but not limited to, any edible food grade oil known to those skilled in the art (e.g., corn, soybean, canola, rapeseed, olive, peanut, algal, nut and/or vegetable oils, fish oils or a combination thereof). The hydrophobic phase can comprise any one or more hydrogenated or partially hydrogenated fats and/or oils, and can include any dairy or animal fat or oil including, for example, dairy fats.

It will be readily apparent that, consistent with the broader aspects of the invention, the hydrophobic phase can comprise any natural and/or synthetic lipid components including, but not limited to, fatty acids (saturated or unsaturated), glycerols, glycerides and their respective derivatives, phospholipids and their respective derivatives, glycolipids, phytosterol and/or sterol esters (e.g. cholesterol esters, phytosterol esters and derivatives thereof), as may be required by a given food or beverage end use application. The present invention, therefore, contemplates a wide range of oil/fat and/or lipid components of varying molecular weight and comprising a range of hydrocarbon (aromatic, saturated or unsaturated), alcohol, aldehyde, ketone, acid and/or amine moieties or functional groups.

Notwithstanding the aforementioned representative phase compositions, each such phase can comprise one or more components at least partially soluble therein, such components limited only by compositional compatibility, processing technique or parameters, and/or a particular desire to food or beverage end use application. For example, without limitation, each such phase can comprise one or more such components to provide a corresponding functional or performance characteristic. Representative of such considerations, the hydrophobic phase and aqueous phase(s) can comprise a natural and/or artificial flavor component (e.g., peppermint, citrus, cocoanut or vanilla) as would be understood by those skilled in the art. By way of further illustration, a hydrophobic phase can also comprise one or more preservatives, antioxidants, colorants, carotenoids, terpenes and/or nutritional components, such as fat soluble vitamins, at least partially miscible therewith.

In part, the present invention can also be directed to a system comprising a first aqueous phase comprising a gelling component; a hydrophobic phase thereabout comprising a lipid component; and a factor or reagent at least partially sufficient to induce assembly, gelling or agglomeration of the gelling component. In certain embodiments, such gelation, assembly and/or agglomeration can be achieved upon heating, change in pH, change in ionic strength, change in solution composition, and/or introduction of one or more single- or multi-charged components. With regard to the latter, in certain such embodiments, gelation can be induced by addition of metal ions such as but not limited to Na⁺, K⁺, Ca⁺², Fe⁺², Mg⁺² Cd⁺² and Zn⁺² and metal ions having higher oxidation states such as but not limited to Al⁺³ and Fe⁺³. Such system gelation can be ion-induced with, for instance, a gelling component comprising an alginate. Alternatively, monovalent or multi-valent anionic ions can also be used to induce gelation in some systems, such anions, including but not limited to chloride, sulfate, tripolyphosphate and other anions as would be understood by those skilled in the art made aware of this invention. In other such systems, temperature can be used to denature a proteinaceous component, thereby inducing gelation.

In certain embodiments, such a system can comprise a continuous second aqueous phase about the aforementioned hydrophobic phase, with the first aqueous phase comprising either a sol or a gel. With regard to the latter, a gel-inducing factor or reagent can be introduced prior to, contemporaneous with, or after introduction of the second aqueous phase to such a system. Compositionally, a first aqueous phase, a hydrophobic phase and a second aqueous phase can be as described above.

In part, the present invention can also comprise a method of preparing a multi-phase emulsion composition. Such a method can comprise providing an aqueous phase comprising a biopolymeric gelling component; contacting the first aqueous phase with a hydrophobic phase comprising a lipid component; and contacting the hydrophobic phase with a second aqueous phase. Such phase compositions can be as described above. The first aqueous phase can be assembled, agglomerated and/or gelled before contact/introduction of the second aqueous phase, contemporaneous therewith, or at a time subsequent thereto. Regardless, introduction of such a gel-inducing factor or reagent can improve the physical and/or mechanical properties of the first aqueous phase and/or enhance overall stability of the multi-phase emulsion.

In certain embodiments, contact of a first aqueous phase and a hydrophobic phase can comprise inter-phase mixing and/or homogenization, optionally in the presence of a surface active agent at least partially soluble in the hydrophobic phase. Such a surface active agent can comprise, but is not limited to, a functionally-effective amount or quantity of any one or more lecithin, phospholipid, sorbitan ester, sucrose ester, mono- or polyglycerol fatty acid ester, fatty acid or polymerized fatty acid components and combinations thereof. Likewise, subsequent contact of a hydrophobic phase with a second aqueous phase can comprise inter-phase mixing and/or homogenization, also optionally in the presence of a functionally-effective amount of a surface active agent at least partially soluble in water. Such surface active components can be selected from, but are not limited to, any one or more food grade small-molecule surfactants, phospholipids, proteins, polysaccharides and combinations thereof.

Consistent with various other embodiments of this invention, such water-soluble surface active components can comprise any one or more of a combination of emulsifier and polymeric components of the sort to provide an at least partially indigestible food-grade interfacial membrane surrounding the hydrophobic phase, such combinations/membranes as can be substantially unaffected by solution, conditions and/or digestive enzymes, thereby further reducing absorption, uptake and/or release of the hydrophobic phase into a subject digestive tract. Such combinations and resulting interfacial membranes or layers can be as more thoroughly described in co-pending application Ser. No. 11/078,216 filed Mar. 11, 2005, the entirety of which is incorporated herein by reference.

In part, the present invention can also be directed to a method of using a biopolymeric gelling component to affect one or more mechanical properties and/or stabilize the aqueous phase of a corresponding emulsion. Such stability and/or effect can be understood with respect to food processing conditions, including but not limited to mechanical and thermal processing. Such a method can comprise providing an aqueous component comprising a biopolymeric gelling component; emulsifying or contacting the aqueous component with a hydrophilic component comprising a lipid component; and inducing at least partial gelation, assembly, and/or agglomeration of the gelling component. As discussed more thoroughly above, such induction can comprise heating, change in pH, ionic strength and/or solution composition and/or introduction of a single- or multi-charged reagent, including but not limited to one or more mono- or multi-valent metal ions discussed above. Such an emulsion can be emulsified or contacted with a second aqueous phase, with such gelation thereafter. The resulting multi-phase emulsion can subsequently be incorporated into one or more food products, as would be understood in the art and/or for reasons discussed elsewhere herein.

With respect to the compositions, systems and/or methods of the present invention, the phases and/or components thereof can suitably comprise, consist of, or consist essentially of any of those mentioned above. Each such phase or component is compositionally distinguishable, characteristically contrasted and can be practiced in conjunction with the present invention separate and apart from another. Accordingly, it should also be understood that the inventive compositions, systems and/or methods, as illustratively disclosed herein, can be practiced or utilized in the absence of any one phase, component and/or step which may or may not be disclosed, referenced or inferred herein, the absence of which may or may not be specifically disclosed, referenced or inferred herein.

### BRIEF DESCRIPTION OF THE DRAWINGS

FIG. 1. (Prior Art) Schematic diagram of the two-step homogenization procedure used to prepare water-in-oil-in-water (W/O/W) emulsions.

FIG. 2. (Prior Art) Schematic diagram illustrating some common instability mechanisms associated with the internal water droplets in water-in-oil-in-water (W/O/W) emulsions.

FIG. 3. Schematic diagram of the three-step homogenization procedure used to prepare water-in-oil-in-water (W/O/W) emulsions containing gelled water droplets, representative of one or more embodiments in accordance with this invention.

FIG. 4. Digital image of the microstructure of a W/O/W emulsion consisting of small water droplets (d<1 μm, 10 wt % whey protein isolate (WPI), pH 7, 100 mM NaCl) trapped within larger oil droplets (d˜6 μm, 8 wt % polyglycerol polyricinoleate in corn oil), which are dispersed in a continuous aqueous phase (2 wt % Tween 20, pH 7, 100 mM NaCl). This emulsion was produced using a high pressure valve homogenizer (W/O) followed by a membrane homogenizer (W/O/W).

FIG. 5. Influence of heat treatment on the microstructure of PGPR-stabilized W/O emulsions (20 wt % aqueous phase, 80 wt % oil phase). Oil and aqueous phases were either heated to 50° C. (heated) or kept at room temperature (nonheated) before emulsification.

FIG. 6. Microstructure of PGPR-stabilized emulsions (20 wt % aqueous phase, 80 wt % oil phase). No-WPI, W/O emulsions that did not contain WPI; WPI-no-Gel, W/O emulsions that contained 15% WPI; WPI-Gel, W/O emulsions that contained 15% WPI and were heat-treated at 80° C. for 20 min after preparation to gel the protein.

FIG. 7. Dependence of transmembrane fluxes on the number of passes through the membrane homogenizer for W/O/W emulsions consisting of 20 wt % disperse phase (W/O emulsions) and 80 wt % aqueous phase (Tween 20 solution).

FIG. 8. Optical microscopy images of W/O/W emulsions prepared by membrane emulsification using different numbers of passes through the homogenizer.

FIGS. 9A-B. Dependence of mean particle diameters (d₃₂ and d₄₃, respectively) of W/O/W emulsions on the number of passes through the membrane homogenizer.

FIGS. 10A-C. Dependence of particle size distributions of W/O/W emulsions on the number of passes through the membrane homogenizer.

FIG. 11. Optical microscopy images of W/O/W emulsions prepared by high-pressure homogenization.

FIGS. 12A-B. Dependence of mean particle diameters (d₃₂ and d₄₃, respectively) of W/O/W emulsions prepared using a high-pressure valve homogenizer on the operating conditions: homogenization pressure and number of passes (in parentheses).

FIGS. 13A-C. Dependence of particle size distributions of W/O/W emulsions prepared using a high-pressure valve homogenizer on the operating conditions: homogenization pressure and number of passes (in parenthesis).

### DETAILED DESCRIPTION OF CERTAIN EMBODIMENTS

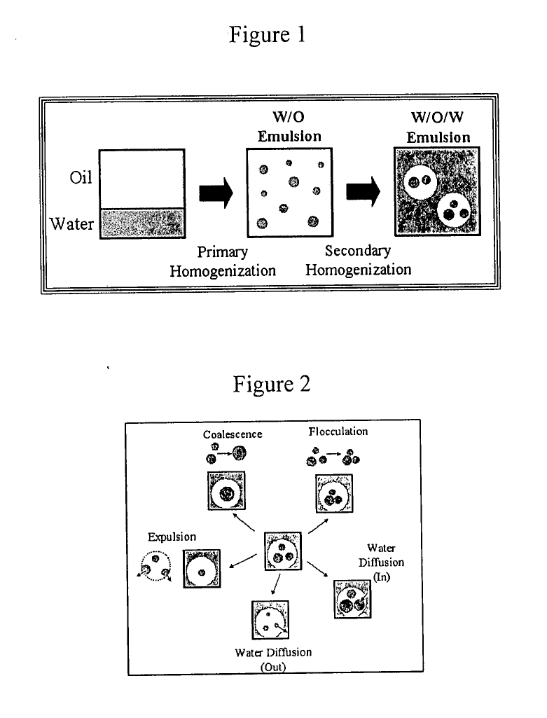

Benefits and advantages associated with various embodiments of this invention can be discussed in the context of gelled biopolymer particles in an initial W/O emulsion, in preparation of a W/O/W emulsion. Such gelled biopolymer particles are formed by gelling a biopolymer trapped inside water droplets in an initial W/O emulsion. Gelled biopolymer particles have a greater mechanical rigidity and cohesiveness than non-gelled water droplets, and so they are less susceptible to aggregation and water-diffusion instability mechanisms during storage. In addition, they are more stable to the extremely high mechanical stresses experienced by the water droplets when the initial W/O emulsion is homogenized with an aqueous solution to form the W/O/W emulsion (FIG. 1). Normally, these intense mechanical stresses destabilize the liquid water droplets and reduce the amount of water encapsulated inside the W/O droplets. (See, e.g., FIG. 2.)

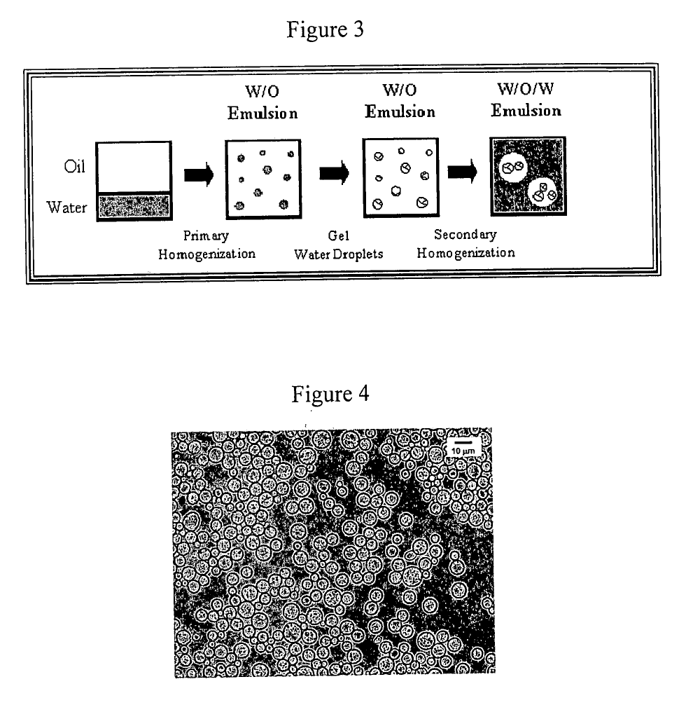

In contrast, W/O/W emulsions of this invention containing gelled water droplets can be prepared by including an additional biopolymer gelation step into the overall production process (FIG. 3). For purposes of the present compositions and/or methods, it will be understood by those skilled in the art that the term “emulsion”, unless otherwise indicted, means a dispersion of immiscible liquid phases or a dispersion where an aqueous phase thereof is at least partially gelled. Initially, a W/O emulsion can be prepared by homogenizing an aqueous phase containing a gelling agent (e.g., ranging from about 0.1 wt. % to about 20 wt. % of the inner aqueous phase) with an oil phase containing an oil-soluble surface active agent or emulsifier (e.g., ranging from about 1 wt. % to about 20 wt. % of the oil phase, or less). This emulsion can then be treated to induce or promote gelation of the gelling agent inside the water droplets. The W/O emulsion containing the gelled biopolymer particles can then be homogenized with an aqueous solution containing a water-soluble surface active agent or emulsifier (e.g., ranging from about 0.1 wt. % to about 20 wt. % of the outer aqueous phase) to form the W/O/W emulsion, using standard commercially-available homogenizer apparatus and operational parameters.

The water droplets in W/O/W emulsions can be gelled using a variety of different physicochemical mechanisms depending on the type of biopolymer gelling agent used, to provide a gel network or matrix therein. The most commonly-used gelling agents in foods are proteins and polysaccharides, such as whey protein, gelatin, casein, carrageenan, pectin, xanthan and alginate. Each such gelling agent can be made to gel using one or more methods, factors and/or reagents depending on the precise molecular basis of the gelation mechanism. For instance, biopolymer solutions can be made to gel by decreasing or increasing the temperature, or by altering the pH or ionic composition of the system.

Gelled biopolymer particles can be formed by thermal gelation of globular proteins initially dispersed in the water phase of a W/O emulsion (FIG. 4). Globular proteins, such as those from milk, egg or soy, form gels when heated above their thermal denaturation temperature. With reference to this illustration, the unfolded proteins expose non-polar and sulfhydryl containing amino acids that promote intermolecular hydrophobic and disulfide cross-links that can lead to the formation of a three-dimensional gel network or matrix. One of the advantages of using globular protein gels is that they are thermally irreversible: once formed they remain intact when the temperature is altered. Such an effect can be useful because food emulsions should remain stable over the wide range of temperatures experienced during their production, storage, transport and utilization. Representative of this invention, a W/O/W emulsion containing gelled biopolymer particles is shown in FIG. 4.

In certain embodiments, useful W/O/W emulsions contain small water droplets (less than about 1 μm) and small oil droplets (e.g., less than about 2 to about 5 μm) that do not change size, location or aggregation state over time due to water diffusion, flocculation, coalescence, Ostwald ripening or gravitational separation. The results illustrated in FIG. 4 demonstrate such emulsions are available through this invention.

As shown above, various deficiencies and shortcomings in the art are addressed and resolved. In doing so, this invention also affords the following benefits and advantages: the stability of the W/O/W emulsion is improved by gelling the water droplets inside a W/O emulsion; gelled particles can be prepared using all food grade ingredients (e.g., proteins, polysaccharides and minerals); gelled particles can be prepared using simple and currently-used food processing operations (e.g., mixing, heating, homogenization); and the stability of the W/O/W emulsions to environmental stresses are greatly enhanced, increasing the shelf life of a corresponding food or beverage product.

Accordingly, this invention can find wide range application in reduced fat or low-calorie fatty food products where the physicochemical properties and quality attributes of conventional fatty food products are desired; that is, for example, in emulsion-based food products where conventional fat droplets are replaced by fat droplets containing gelled biopolymer particles, e.g., in mayonnaise, dressings, yogurts, deserts, sauces, soups, dips, beverages, meat products, creamers, and pet foods-to list but a few. Commercial application continues to develop, using food-grade components and through ready incorporation into current production facilities, all without further regulatory impediment.

### EXAMPLES OF THE INVENTION

The following non-limiting examples and data illustrate various aspects and features relating to the emulsions, compositions and/or methods of the present invention, including the preparation of water-in-oil-in-water emulsion compositions comprising various gelled biolpolymeric components, as are available through the methodologies described herein. In comparison with the prior art, the present emulsions, compositions and/or methods provide results and data which are surprising, unexpected and contrary thereto. While the utility of this invention is illustrated through the use of several emulsions, compositions and biopolymeric components and lipid components which can be used therewith, it will be understood by those skilled in the art that comparable results are obtainable with various other emulsions, compositions and biolpolymeric and lipid components, as are commensurate with the scope of this invention.

Materials and Methods.

Materials. Polyglycerol polyricinoleate (PGPR 4150, Palsgaard, Denmark) prepared by the esterification of condensed castor oil fatty acids with polyglycerol was obtained from Palsgaard Industri de Mexico (St. Louis, Mo.). As stated by the manufacturer, the polyglycerol moiety of the PGPR was predominantly di-, tri-, and tetraglycerols (minimum of 70%) and contained not more than 10% of polyglycerols equal to or higher than heptaglycerol. WPI (BiPRO lot JE 015-4-420) was obtained from Davisco Foods International Inc. (Le Sueur, Minn.). As stated by the manufacturer, the powdered WPI had a composition of 97.6 wt % protein, 2.0 wt % ash, and 0.3 wt % fat (dry weight basis) and 4.7 wt % moisture (wet weight basis). Polyoxyethylene-sorbitan monolaurate (Tween 20), sorbitan monostearate (Span 60), sorbitan tristearate (Span 65), sorbitan monooleate (Span 80), analytical grade sodium chloride (NaCl), hydrochloric acid (HCl), sodium hydroxide (NaOH), hexadecane, sodium phosphate (monobasic, anhydrous), and sodium azide (NaN₃) were purchased from the Sigma Chemical Co. (St. Louis, Mo.). Ethanol, toluene, and sodium phosphate (dibasic, anhydrous) were purchased from Fisher Science (Chicago, Ill.). Corn oil (Mazola, ACH Food Companies Inc., Memphis, Tenn.) was purchased from a local supermarket and used without further purification. 1,3,6,8-Pyrenetetrasulfonic acid tetrasodium salt (CAS Registry No. 59572-10-0) was purchased from Fisher Scientific International L.L.C. (Hampton, N.H.). Distilled and deionized water was used for the preparation of all solutions.

### Example 1

Solution Preparation. Emulsifier solution was prepared by dispersing 8 wt % PGPR into corn oil and heating to 50° C. This PGPR concentration was selected because previous studies have shown that it is capable of forming W/O emulsions containing small water droplets with a narrow size distribution (7, 14). Protein solution was prepared by dispersing the desired amount (15 wt %) of WPI powder into 5 mM phosphate buffer solution at pH 7 containing 0.02 wt % sodium azide (as an antimicrobial agent) and 100 mM NaCl (to facilitate gelation) and stirring for at least 2 h at room temperature to ensure complete dissolution. The pH of the WPI solution was adjusted back to pH 7.0 using 1 M HCl if required, and then the solution was heated to 50° C. before emulsification.

### Example 2

Preparation of W/O Emulsions. Water-in-oil emulsions were prepared by homogenizing 20 wt % aqueous phase with 80 wt % oil phase. The emulsions were prepared at 40-50° C. (rather than at room temperature) because the oil phase was less viscous, and the emulsions produced by homogenization had smaller droplet sizes. The aqueous phase with or without 15 wt % WPI was dispersed gradually into the oil phase under agitation with a magnetic stirrer and then blended together using a high-speed blender (M133/1281-0, Biospec Products, Inc., ESGC, Switzerland) at 50° C. for 2 min. The coarse emulsions were then passed through a two-stage high-pressure valve homogenizer (LAB 1000, APV-Gaulin, Wilmington, Mass.) three times: 19 MPa (2700 psi) for the first stage and 2.1 MPa (300 psi) for the second stage. Temperatures of the emulsions were 45 (±1 and 44 (±1° C. when they were fed into and came out of the homogenizer, respectively. After homogenization, the emulsions were cooled to room temperature (˜23° C.). Then, the emulsion containing water droplets with WPI inside was separated into two portions: (i) one portion was maintained at ambient temperature; (ii) the other portion was heat-treated at 80° C. for 20 min. All emulsions were then stored at ambient temperature for 24 h before being analyzed.

In summary, three different W/O emulsions were prepared:

### Example 2a

Emulsion 1 (No-WPI) was prepared by homogenizing 20 wt % aqueous phase (5 mM phosphate buffer, 100 mM NaCl, pH 7) with 80 wt % oil phase (8 wt % PGPR in corn oil).

### Example 2b

Emulsion 2 (WPI-no-Gel) was prepared by homogenizing 20 wt % aqueous phase (15 wt % WPI, 5 mM phosphate buffer, 100 mM NaCl, pH 7) with 80 wt % oil phase (8 wt % PGPR in corn oil). This emulsion was not heat-treated after emulsification.

### Example 2c

Emulsion 3 (WPI-Gel) was prepared by homogenizing 20 wt % aqueous phase (15 wt % WPI, 5 mM phosphate buffer, 100 mM NaCl, pH 7) with 80 wt % oil phase (8 wt % PGPR in corn oil). This emulsion was heat-treated at 80° C. for 20 min to gel the WPI inside the water droplets. (When an aqueous solution with the same composition was heated at 80° C. for 20 min in a glass test tube, it formed a strong optically opaque gel.)

### Example 3

Influence of Environmental Stresses on W/O Emulsion Stability. The properties and stability of the three different types of W/O emulsions were compared after they were subjected to various environmental stresses:

### Example 3a

Shearing. The emulsions were subjected to constant shear for 0-7 min (0, 0.5, 1, 2, 3, 4, 5, and 7 min) using a high-speed blender (M133/1281-0, Biospec Products, Inc.) at room temperature (˜23° C.). The emulsions were then stored at room temperature for 24 h before being analyzed.

### Example 3b

Thermal Processing. Emulsion samples (10 g) were transferred into glass test tubes (internal diameter )=15 mm, height )=125 mm), which were then incubated in a water bath for 30 min at different temperatures ranging from 30 to 90° C. After incubation, the emulsion samples were immediately cooled to ambient temperature in a water bath containing cold tap water. The emulsions were then stored at ambient temperature for 24 h prior to analysis.

### Example 3c

Storage. The emulsions were stored at ambient temperature for 1 day, 1 week, 2 weeks, and 3 weeks before being analyzed.

The properties and stability of the W/O emulsions were then characterized by measuring their particle size, microstructure, and sedimentation stability.

### Example 4

Preparation of W/O/W Emulsions. W/O/W emulsions were prepared using the two-stage emulsification method, as described in the literature. (See, Dickinson, E.; McClements, D. J. Water-in-oil-in-water multiple emulsions. In Advances in Food Colloids; Dickinson, E., McClements, D. J., Eds.; Blackie Academic and Professional: Glasgow, U.K., 1996; pp 280-300.) First, a 20 wt % W/O emulsion was prepared as described above. Second, 20 wt % of this W/O emulsion was homogenized with 80 wt % of aqueous surfactant solution (0.5 wt % Tween 20, 5 mM phosphate buffer, 100 mM NaCl, 0.02 wt % NaN₃, pH 7) using either a membrane homogenizer or a high-pressure valve homogenizer.

### Example 4a

W/O/W Emulsions Prepared Using a Membrane Homogenizer. The W/O emulsions and aqueous surfactant solution were first premixed for several minutes using a stirring bar followed by five passes through a membrane homogenizer at 100 kPa (14.5 psi) (MG-20-5, Kiyomoto Iron Works Ltd., Japan). The pressure vessel was filled with 100 mL of coarse emulsion, and the required driving pressure was built up with compressed air using a pressure regulator (PRG 101, Omega, Stamford, Conn.). The operating pressure was measured with an accuracy of (±1 kPa using a pressure gauge (PG-200-103G-P, Copal Electronics, Tokyo, Japan). When the emulsion had passed through the membrane tube, it was collected into a beaker placed on an electronic balance (Accu-622, Fisher Scientific, Fair Lawn, N.J.). The balance was interfaced to a PC computer to collect time and mass data every 2 s using data acquisition software (AccuSeries USB version 1.2, Fisher Scientific, Fair Lawn, N.J.). The experiments were carried out at 21° C. The membrane used was a SPG membrane (8.5 mm inner diameter×0.8 mm wall thickness) supplied from SPG Technology Co., Ltd. (Sadowara, Japan). The mean pore size of the membrane was 8.0 μm, the effective membrane length was 12 mm, and the effective cross-sectional area was 3.75 cm². The membrane tube was cleaned after use by immersing it for 2 days in ethanol plus 2 days in toluene, followed by heating at 500° C. for 30 min in an electric muffle furnace. Measurements of the flux rate after cleaning indicated that the inherent membrane permeability to pure water was completely restored. The emulsions were stored at ambient temperature for 24 h before being analyzed.

### Example 4b

W/O/W Emulsions Prepared Using a High-Pressure Homogenizer. Multiple emulsions were prepared by blending 20 wt % W/O emulsion and 80 wt % aqueous surfactant solution (0.5 wt % Tween 20 in buffer solution) together using a high-speed blender (M133/1281-0, Biospec Products, Inc.) for 2 min at room temperature. These coarse emulsions were then passed through a two-stage high-pressure valve homogenizer (LAB 1000, APV-Gaulin, Wilmington, Mass.) one to three times at either 7 MPa (1000 psi) or 14 MPa (2000 psi); 9/10 of the pressure from the first stage, 1/10 from the second stage. The emulsions were then stored at ambient temperature for 24 h before being analyzed.

### Example 5

Particle Size Measurements. Average droplet sizes of W/O/W emulsions were measured using a static light scattering instrument. To avoid multiple scattering effects, W/O/W emulsions were diluted to a droplet concentration of approximately ˜0.005 wt % using buffer solution at the pH and NaCl concentration of the sample and stirred continuously throughout the measurements to ensure the samples were homogeneous. The particle size distribution of the emulsions was then measured using a laser light scattering instrument (Mastersizer, Malvern Instruments, Worcestershire, U.K.). This instrument measures the angular dependence of the intensity of laser light (λ=632.8 nm) scattered by a dilute emulsion and then finds the particle size distribution that gives the best fit between experimental measurements and predictions based on light scattering theory. Particle size was reported as volume-surface mean diameter, d₃₂ (=Σnᵢdᵢ³/Σnᵢdᵢ², where nᵢ is the number of particles with diameter dᵢ) and volume-weighted mean diameter, d₄₃ (=Σnᵢdᵢ³/Σnᵢdᵢ³).

The mean size of the droplets in the W/O emulsions was determined by dynamic light scattering. The W/O emulsions were diluted to a droplet concentration of ˜0.5 wt % with hexadecane (refractive index=1.434, viscosity=3.13 mPa s at 25° C.) as a dispersant to avoid multiple scattering effects. The particle size of the emulsions was then measured at 25° C. using a dynamic light scattering instrument (Zetasizer Nano-ZS, Malvern Instruments). This instrument measures the rate of diffusion of particles via intensity fluctuations. Particle size was reported as the scattering intensity-weighted mean diameter, z-average.

### Example 6

Optical Microscopy. Emulsions were gently agitated in a glass test tube before analysis to ensure that they were homogeneous. A drop of emulsion was placed on a microscope slide and then covered with a cover slip. The microstructures of the W/O emulsion and W/O/W emulsions were then observed using a conventional optical microscope (Nikon microscope Eclipse E400, Nikon Corp., Japan) equipped with a CCD camera (CCD-300-RC, DAGE-MTI, Michigan City, Ind.) connected to Digital Image Processing Software (Micro Video Instruments Inc., Avon, Mass.) and an Olympus Vanox optical microscope with a digital camera (Kodak EasyShare LS443, Japan). More than six pictures were taken for each sample, and a representative one was shown.

### Example 7

Sedimentation Stability Measurement. Sedimentation stability measurements were carried out on the W/O emulsions, where the water droplets tend to move downward because they are heavier than the surrounding oil phase. Ten grams of emulsion was transferred into a test tube (internal diameter=15 mm, height=125 mm), tightly sealed with a plastic cap, and then centrifuged at 6500 rpm for 30 min at room temperature (Centric Centrifuge, Fisher Scientific, Indiana, Pa.). The extent of sedimentation was determined visually on the basis of the phase separation after the centrifugation step. However, water separation was not visually apparent in any of the systems investigated.

### Example 8

Creaming Stability Measurement. Creaming stability measurements were carried out on the W/O/W emulsions, where the W/O droplets tend to move upward because they are lighter than the surrounding water phase. Ten grams of emulsion were transferred into a test tube (internal diameter=15 mm, height=125 mm), tightly sealed with a plastic cap, and then stored for 1 day and 7 days at room temperature. After storage, some emulsions separated into an optically opaque “cream” layer at the top and a transparent (or turbid) “serum” layer at the bottom. The serum layer is defined as the sum of any turbid and transparent layers. The total height of the emulsions (H_{E}) and the height of the serum layer (H_{S}) were measured. The extent of creaming was characterized as % serum=100(H_{S}/H_{E}). The percent serum provided indirect information about the extent of droplet aggregation in an emulsion. All measurements were made on at least two freshly prepared samples.

### Example 9

Determination of Yield. The “yield” of a W/O/W emulsion was defined as the percentage of water-soluble dye retained within the inner aqueous phase droplets following the homogenization of the W/O emulsion with aqueous phase. Initially, there was prepared a standard curve of absorbance versus dye concentration for the water-soluble fluorescent dye used in this study: 1,3,6,8-pyrenetetrasulfonic acid tetrasodium salt (PTSA). A stock dye solution was prepared by dissolving 0.01% (w/v) PTSA in buffer solution (5 mM phosphate, 100 mM NaCl, pH 7). A standard curve was then prepared (r²=0.996) by measuring the absorbance of diluted stock dye solutions at 374 nm using a UV-visible spectrophotometer. The dye concentration in the external aqueous phases collected from W/O/W emulsions was then determined using this standard curve.

PTSA (0.2%) was dispersed in the aqueous phase used to prepare the W/O emulsions as described above. W/O/W emulsions were then prepared by homogenizing 20 wt % W/O emulsions with 80 wt % aqueous surfactant solution (0.5 wt % Tween 20 in buffer solution) using either the HPVH (two passes, 14 MPa) or the MH (five passes, 0.1 MPa). Samples of the W/O/W emulsions were then centrifuged for 20 min at 40000 rpm using a centrifuge (Sorvall Centrifuges, DuPont Co., Wilmington, Del.) to separate them into a creamed layer and a serum layer. An aliquot (3 mL) of the serum layer from each centrifuged sample was clarified using a syringe-driven filter unit (Millipore Corp., Bedford, Mass.), and their absorbance was recorded at 374 nm. This procedure was repeated on similar emulsions that had been prepared without dye to obtain blank values, and these were subsequently subtracted from their counterparts with dye. The concentration of dye present in the serum layer was determined from the standard curve.

The entrapment yield (Y) was expressed as the fraction of dye that remained encapsulated within the water droplets after homogenization

$$Y = \frac{{M}_{i} - {M}_{e}}{{M}_{i}} = 1 - \frac{{M}_{e}}{{M}_{i}} \qquad ( 1 )$$

where Mᵢ is the mass of dye initially present in the internal water droplets in the W/O emulsion and Mₑ is the mass of dye present in the external water phase in the W/O/W emulsion after homogenization. The entrapment yield can be calculated if it is assumed that the amount of dye released from the inner water droplets is proportional to the amount of water released and that the dye is released due to expulsion of the internal water droplets during formation of the W/O/W emulsion. The mass of dye initially present in the internal water droplets in the W/O emulsion is then given by
Mᵢ=CᵢVᵢ=Cᵢ×φ_{WO}×φ_{WOW}×V_{WOW} (2)

The mass of dye present in the external water phase in the W/O/W emulsion after homogenization is then given by

$$\begin{matrix}{M}_{e} = {C}_{e} [ {V}_{e} + ( 1 - Y ) \times {V}_{i} ] \\ = {C}_{e} [ ( 1 - {ϕ}_{WOW} ) + ( 1 - Y ) \times {ϕ}_{WO} \times {ϕ}_{WOW} ] \times {V}_{WOW}\end{matrix} \qquad ( 3 )$$

Here, Cᵢ is the dye concentration in the internal aqueous phase of the W/O emulsion and Cₑ is the dye concentration measured in the external aqueous phase of the W/O/W emulsion after homogenization. Vᵢ, Vₑ, and V_{WOW} are the volume of the internal water phase used to prepare the W/O emulsion, the volume of the external water phase used to prepare the W/O/W emulsion, and the volume of the overall emulsion, respectively. In addition, φ_{WO} is the volume fraction of water droplets in the W/O emulsion, whereas φ_{WOW} is the volume fraction of W/O droplets in the W/O/W emulsion. Substitution of eqs 2 and 3 into eq gives

$$Y = 1 - \frac{{C}_{e}}{{C}_{i} - {C}_{e}} ( \frac{1 - {ϕ}_{WOW}}{{ϕ}_{WO} {ϕ}_{WOW}} ) \qquad ( 4 )$$

The entrapment yield is expressed as a percentage: % yield=100 Y. For the particular system used in this study, Cᵢ=0.2% w/v, φ_{WO}≈0.2, and φ_{WOW}≈0.2. Hence, the yield is given by the following approximate expression: % yield=100×(1−100Cₑ/[1−5Cₑ]), when Cᵢ and Cₑ are expressed in % w/v.

### Example 10

Viscosity Measurements. The viscosity of pure oil and pure oil containing 8 wt % PGPR was measured using a dynamic shear rheometer (Constant Stress Rheometer, CS-10, Bohlin Instruments, Cranbury, N.J.). Samples were contained in a concentric cylinder cell (the diameter of the rotating inner cylinder was 25 mm, and the diameter of the static outer cylinder was 27.5 mm), and the viscosity of the samples was measured by heating and cooling the samples in a range of temperature from 25 to 90° C. at a shear stress of 0.1 Pa. No influence of the direction of the temperature change (heating versus cooling) on the measured viscosity was observed. Viscosity versus shear rate measurements indicated that both systems were Newtonian fluids; that is, the viscosity was independent of shear rate.

### Example 11

Statistical Analysis. Experiments were performed twice, and the mean and spread of the data were calculated from these duplicate measurements.

### Example 12

Selection of PGPR as a Lipophilic Emulsifier for the Preparation of Water-in-Corn Oil Emulsions. The purpose of this experiment was to identify a non-limiting lipophilic emulsifier to prepare stable W/O emulsions. A number of nonionic surfactants (8 wt %) with a low hydrophile-lipophile balance (HLB) were therefore tested for their ability to form stable W/O emulsions: Span 60 (HLB=4.7), Span 65 (HLB=2.1), Span 80 (HLB=4.3), and PGPR (HLB=˜3). Span 60 and Span 65 were insoluble in corn oil at room temperature under conditions utilized. Span 80 was soluble in corn oil at room temperature, but when it was homogenized with water, the resulting W/O rapidly phase-separated under the particular conditions utilized. Previous researchers have prepared stable W/O emulsions using Span 80, but they used hydrocarbons (kerosene, C₁₀H₂₂ to C₁₆H₃₄) as the oil phase rather than corn oil. The reason for this observed difference might therefore be due to the different properties of the particular oils used—edible oils tend to be less hydrophobic and contain more surface active impurities than hydrocarbons. PGPR was found to be soluble in corn oil and that it could be used to prepare W/O emulsions that appeared to be stable at room temperature (˜23° C.).

### Example 13a

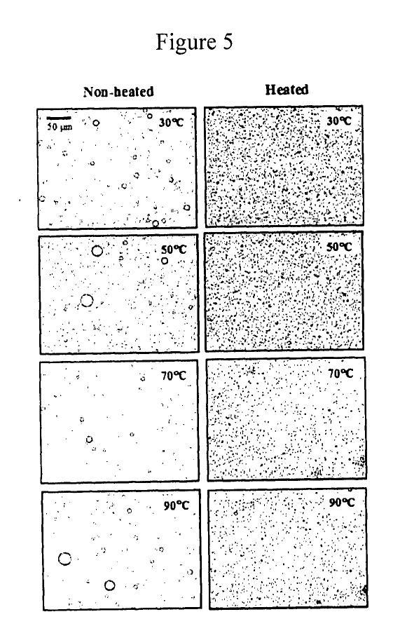

Optical microscopy indicated that the present emulsions contained a population of relatively large water droplets (FIG. 5, nonheated). It was observed that the PGPR-corn oil mixture was highly viscous at room temperature and postulated that this might result in inefficient disruption of the water droplets inside the high-pressure homogenizer. It was noticed that the PGPR-corn oil mixture became much less viscous upon heating. The influence of preparation temperature on the formation of the W/O emulsions was examined by preparing W/O emulsions under two different conditions: (i) heated emulsion (˜40-50° C.), the oil and aqueous phases were heated to 50° C. then homogenized; or (ii) nonheated emulsion (˜23° C.), the oil and aqueous phases were homogenized at room temperature. The temperature range of 40-50° C. was used for the preparation of the heated emulsions because this was sufficiently high to cause an appreciable decrease in oil phase viscosity while still being appreciably below the thermal denaturation temperature (Tₘ˜74° C.) of whey protein (so no gelation of the aqueous phase would occur prior to homogenization if WPI was present).

### Example 13b

The microstructure of the nonheated and heated PGPR emulsions was then characterized by optical microscopy (FIG. 5). Homogenizing the W/O emulsions at an elevated temperature clearly led to a smaller water droplet size. As mentioned earlier, this was probably because the viscosity of the oil phase decreased appreciably on heating, which made it easier for droplet disruption to occur within the homogenizer. For example, the viscosity of the oil phase (+PGPR) was 68 and 34 mPa s at 25 and 45° C., respectively. In addition, there was no evidence of water droplet sedimentation in the W/O emulsions after 1 month of storage at room temperature, which suggested that they were stable to droplet flocculation. The mean droplet diameter (z-average) of both emulsions measured by dynamic light scattering was around 300 nm. Nevertheless, these measurements should be treated with caution because dynamic light scattering is not sensitive to the presence of slow-moving particles larger than about 3 μm, and there were clearly some droplets larger than this in our W/O emulsions.

### Example 14

In subsequent experiments we intended to gel the aqueous phase was gelled by incorporating WPI and heating the W/O emulsion above the thermal denaturation temperature of the proteins (see below). It is widely known that temperature can have a pronounced affect on the functional properties of nonionic surfactants; for example, surfactant molecules tend to become dehydrated and more lipophilic with increasing temperature. Therefore, the effect of thermal processing (30-90° C. for 30 min) on the PGPR-stabilized emulsions was examined. However, there was no significant difference in the microstructure (FIG. 5) or mean particle size of the emulsions that had undergone heat treatment (data not shown). This observation is consistent with a previous study that reported that lipophilic surfactants did not change their character upon heating as much as hydrophilic surfactants. In light of these results, the W/O emulsions used in the remainder of this study were prepared using PGPR as the emulsifier and were heated to 50° C. prior to homogenization.

### Example 15

Preparation and Characterization of W/O Emulsions. This study examined 1) improving the stability of W/O/W emulsions by the thermal gelation of whey proteins contained within the inner aqueous phase of the initial W/O emulsions; 2) the influence of WPI gelation on the stability of W/O emulsions; and 3) the influence of protein concentration (0-20 wt % with 2 wt % increments) on the ability of WPI to form a gel in aqueous solutions (5 mM phosphate buffer, 100 mM NaCl, pH 7) heated at 80° C. for 20 min. It was found that optically opaque gels that would not flow when the test tubes containing them were inverted could be formed at WPI concentrations ≧4 wt %. A WPI concentration of 15 wt % was therefore selected for subsequent studies because it was well above this minimum value and it gave optically opaque (white) gels that appeared to be homogeneous and firm.

### Example 15a

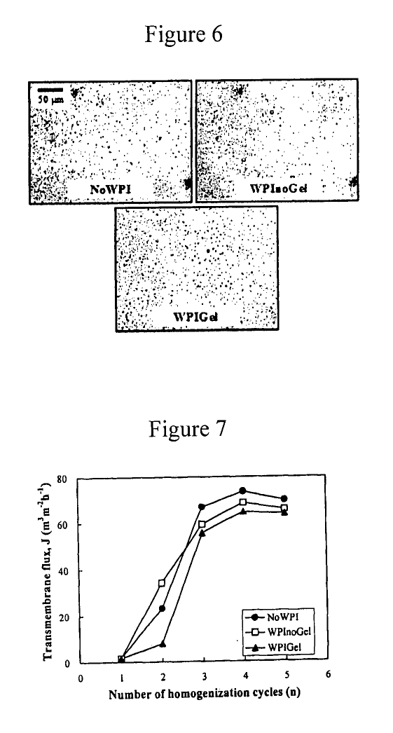

Three 20 wt % W/O emulsions were prepared by homogenizing aqueous phase (0 or 15 wt % WPI, 100 mM NaCl, pH 7) and oil phase (8 wt % PGPR in corn oil) together as described earlier: (i) 0 wt % WPI (No-WPI); (ii) 15% WPI, without heating (WPI-no-Gel); and (iii) 15% WPI, with heating to 80° C. for 20 min to gel the protein (WPI-Gel). After preparation, all three W/O emulsions contained relatively small water droplets that were evenly dispersed throughout the oil phase (FIG. 6).

### Example 15b

Changes in the microstructure and sedimentation stability of these emulsions were then measured after they had been subjected to various environmental stresses, that is, (i) long-term storage (3 weeks at room temperature); (ii) shearing (0.5-7 min in a high-speed blender), and (iii) heating (30-90° C. for 30 min). Optical microscopy measurements indicated that there was no change in the overall microstructure of the three emulsions after storage, shearing or heating (data not shown), with the microstructures appearing similar to those shown in FIG. 6.

### Example 15c

In addition, all three emulsions were stable to gravitational separation after they had been subjected to these environmental stresses, there being no evidence of the formation of an oil-rich layer at the top of the emulsion due to downward movement of the water droplets after 3 weeks of storage. These measurements indicated that the presence of gelled or nongelled WPI in the aqueous phase neither improved nor adversely affected the stability of the W/O emulsions. The stability of these emulsions may have been because the relatively high viscosity of the oil phase at room temperature (˜68 mPa s) retarded movement (collisions or sedimentation) of the water droplets.

### Example 16

Preparation and Characterization of W/O/W Emulsions. The practical utilization of many W/O/W emulsions has been limited because the relatively large size of the oil droplets they contain makes them highly susceptible to creaming, coalescence, and flocculation. The oil droplet size in conventional O/W emulsions can usually be reduced by using intense homogenization conditions to disrupt the droplets, such as those found in high-pressure valve homogenizer. However, this type of homogenizer usually cannot be used to prepare W/O/W emulsions because the intense homogenization conditions required to obtain small oil droplets promotes rupture of the internal water droplets, which leads to loss of water. It was postulated that the gelation of the water droplets within the W/O emulsions used to prepare a W/O/W emulsion would reduce the tendency for water loss to occur during the secondary homogenization stage. Hence, it should be possible to use relatively high-intensity homogenization devices to prepare W/O/W emulsions, thereby creating smaller oil droplet sizes.

The effect of mechanical emulsification methods on the droplet characteristics of W/O/W emulsions containing WPI in the internal aqueous phase was investigated. W/O/W emulsions were prepared by homogenizing 20 wt % of W/O emulsion and 80 wt % aqueous solution (0.5 wt % Tween 20 in buffer) together using either a low-intensity (membrane homogenizer) or a high-intensity (high-pressure valve homogenizer) mechanical device. For each homogenization device, we prepared W/O/W emulsions using W/O emulsions containing either 0 or 15 wt % gelled (at 80° C., 20 min) or nongelled WPI in the aqueous phase.

### Example 16a

W/O/W Emulsions Prepared by Premix Membrane Emulsification. One of the most important parameters describing the efficient operation of a membrane homogenizer is the transmembrane flux, that is, the volume of material that passes through the membrane per unit of time per unit of surface area. The dependence of the transmembrane flux on emulsion composition and number of homogenization passes is shown in FIG. 7. For all three W/O/W emulsions, the flux increased as the number of passes increased until it reached a limiting value at four passes, after which it decreased slightly. This indicates that all of the large droplets in the feed emulsion were completely disrupted, and only fine droplets that can easily pass through the pores remained at four passes.

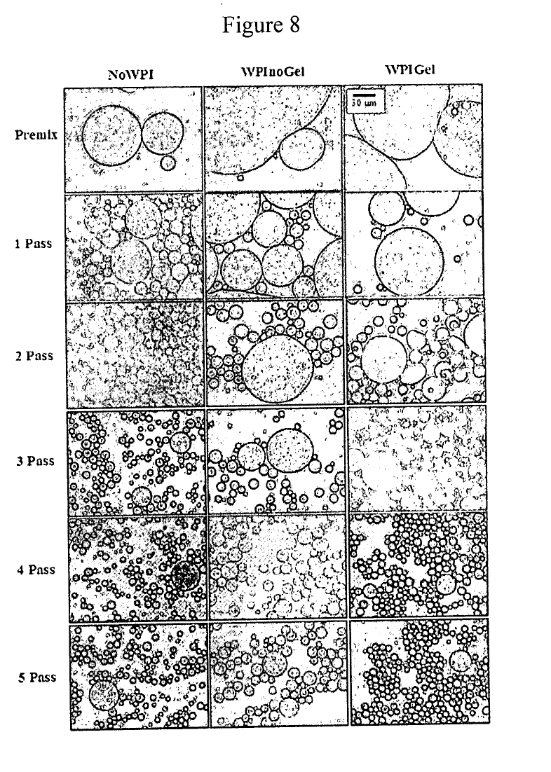

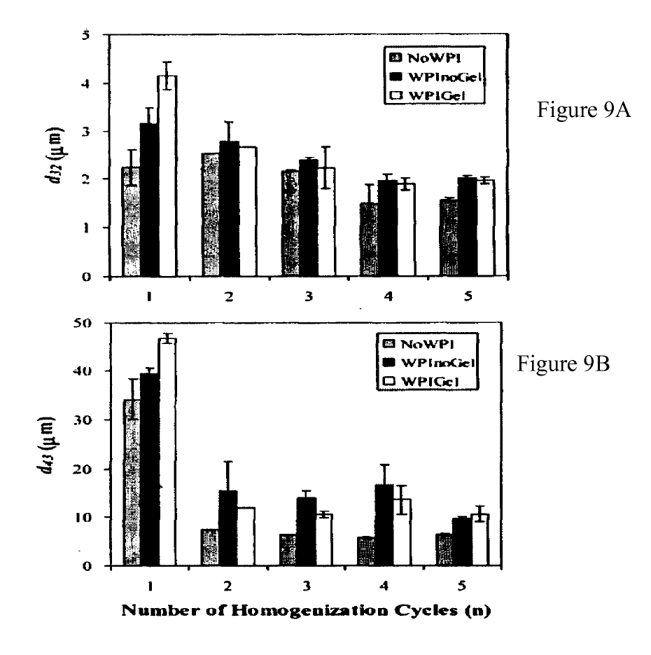

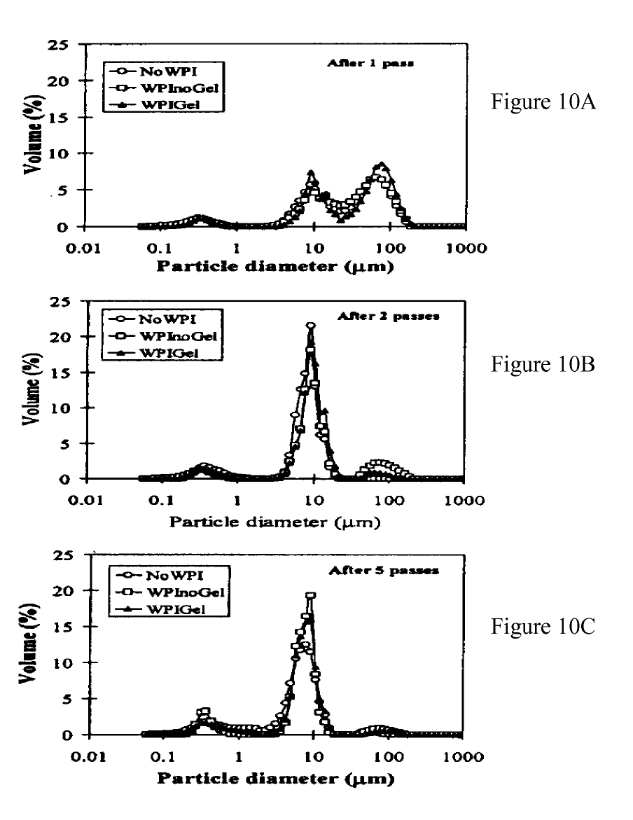

The presence of W/O/W droplets in these emulsions was confirmed by optical microscopy (FIG. 8). Some coarse water droplets were visible within some of the oil droplets, whereas fine water droplets were visible only as an inhomogeneous “texture” within the oil droplets. The mean diameter of the oil droplets decreased as the number of passes increased, asymptotically approaching a limiting minimum value (FIG. 9). The volume-surface mean particle diameter (d₃₂), which is more sensitive to the presence of small particles, of the W/O/W emulsions decreased fairly gently as the number of passes increased, eventually reaching values of 1.56±0.04 μm for No-WPI, 2.01±0.05 μm for WPI-no-Gel, and 1.95±0.07 μm for WPI-Gel emulsions after five passes. On the other hand, there was a fairly steep decrease in the volume-weighted mean particle diameter (d₄₃), which is more sensitive to the presence of any large particles, when the number of passes increased from one to two, after which the mean particle diameter reached a fairly constant value: 6.4±0.3 μm for No-WPI, 9.7±0.3 μm for WPI-no-Gel, and 10.5±1.6 μm for WPI-Gel emulsions after five passes. This change could also be seen when the full particle size distributions of the emulsions were examined (FIG. 10). Although the W/O/W emulsions prepared by membrane emulsification displayed bimodal or trimodal distributions, the majority of droplets fell within a fairly narrow particle size range around 8 μm. For example, the d<1, 1<d<10, and d>10 μm values after five passes were 15, 75, and 10 vol % for No-WPI; 12, 78, and 10 vol % for WPI-no-Gel; and 12, 76, and 13 vol % for WPI-Gel W/O/W emulsions. There was a small population (≦15%) of fine particles (d<1 μm) measured by laser diffraction in the emulsions after membrane homogenization. This would account for the fact that when the emulsions were stored at room temperature for 24 h, they separated into an opaque layer at the bottom (containing the small droplets): that is, serum percentages after five passes were 66, 54, and 66% for No-WPI, WPI-no-Gel, and WPI-Gel after storage for 1 day, respectively.

These measurements suggested that there was not a strong dependence of the oil droplet size in the W/O/W emulsions on the nature of the aqueous phase within the initial W/O emulsion. It seems that the size distributions of droplets produced in the W/O/W emulsions were mainly determined by the homogenizer conditions. However, the emulsions containing WPI (gelled or not gelled) had somewhat larger mean droplet diameters than those containing no WPI (FIG. 9), suggesting that it may be harder to break up the W/O phase into droplets when the protein is present.

The yield of the W/O/W emulsions prepared by membrane homogenization was determined by measuring the percentage of dye that had been released from the internal water droplets after homogenization. The % yield was greater than 99.8% for the No-WPI, WPI-no-Gel, and WPI-Gel W/O/W emulsions, which indicated that the internal water droplets in all of the original W/O emulsions were not disrupted by the membrane homogenization process.

### Example 16b

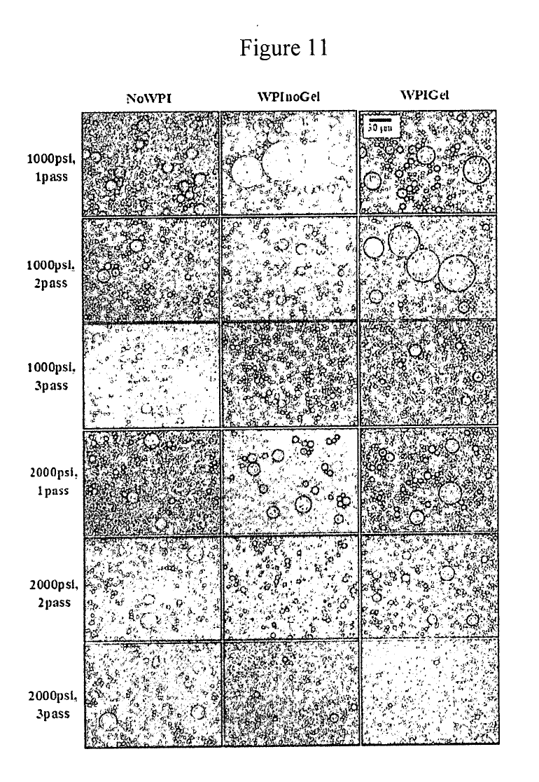

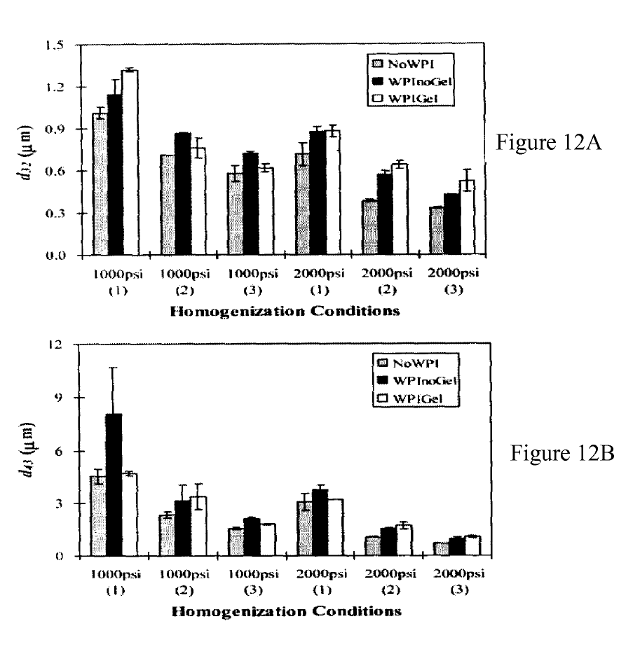

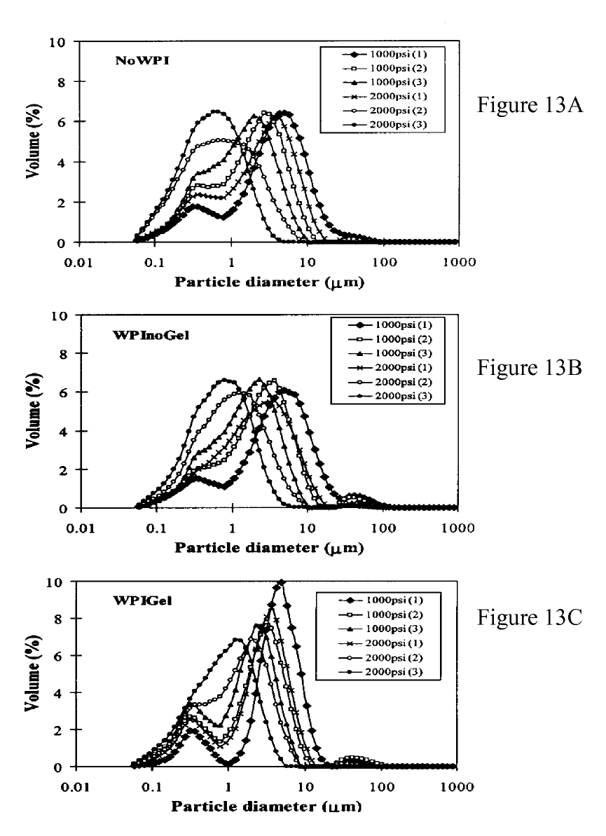

W/O/W Emulsions Prepared by High-Pressure Homogenization. To inhibit creaming by making the outer droplets as small as possible, W/O/W emulsions were prepared by high-pressure valve homogenization using different homogenization conditions: pressure=1000 psi (7 MPa) or 2000 psi (14 MPa); number of passes=1-3. The microstructures of W/O/W emulsions produced using this process are shown in FIG. 11. Emulsions prepared using high-pressure valve homogenization contained smaller droplets than those prepared using membrane emulsification (FIGS. 8 and 11). Small water droplets could be seen entrapped within some of the larger oil droplets produced using relatively mild homogenization conditions (two or fewer passes at 1000 psi; one of fewer passes at 2000 psi). However, it was not possible to see the water droplets when more severe homogenization conditions were used due to the relatively small size of the oil droplets produced. There was no large dependence of the droplet characteristics of the W/O/W emulsions on the presence of WPI and/or on heat gelation (FIGS. 12 and 13). Nevertheless, the W/O/W emulsions containing no WPI had significantly smaller mean droplet diameters (d₃₂ and d₄₃) than those containing WPI, especially after three passes at 2000 psi, again suggesting that it may be easier to disrupt the W/O phase in the secondary homogenization stage when no WPI is present. However, the major factor affecting the droplet size distributions produced was the severity of the homogenization conditions, rather than the composition of the inner aqueous phase (FIGS. 12 and 13). The mean particle diameters (d₃₂ and d₄₃) of the W/O/W emulsions decreased with an increase in homogenization pressure and number of passes, with the largest droplets having been produced at 1000 psi and one pass (d₃₂=1.0, 1.2, and 1.3 μm and d₄₃=4.5, 8.1, and 4.7 μm for No-WPI, WPI-no-Gel, and WPI-Gel, respectively) and the smallest sizes being produced at 2000 psi and three passes (d₃₂=0.3, 0.4, and 0.5 μm and d₄₃=0.7, 1.0, and 1.0 μm for No-WPI, WPI-no-Gel, and WPI-Gel, respectively) (FIG. 12).

In general, W/O/W emulsions prepared by high-pressure valve homogenization contained smaller droplets than those prepared using membrane emulsification (FIG. 9), which could enhance the subsequent stability of W/O/W emulsions to gravitational separation because the velocity at which a droplet moves is proportional to the square of its radius. Indeed, no creaming was observed in all W/O/W emulsions after 1 day of storage except those prepared at 1000 psi and one pass (serum=70, 63, and 71% for No-WPI, WPI-no-Gel, and WPI-Gel, respectively). On the other hand, the particle size distributions prepared by the high-pressure valve homogenizer were appreciably broader than those prepared by the membrane homogenizer (FIGS. 10 and 13).

The yield of the W/O/W emulsions prepared by the high-pressure valve homogenizer was determined by measuring the percentage of dye that had been released from the inner water droplets after homogenization, as explained above (Example 9). The % yield (retained) was 96.0±2.0, 98.8±0.7 and 98.3±0.3 for the No-WPI, WPI-no-Gel, and WPI-Gel W/O/W emulsions, respectively. These results suggest that the internal water droplets in the W/O/W emulsions were highly stable to expulsion during homogenization.

In conclusion, this study and resulting data show that W/O/W emulsions can be produced using either a high-pressure valve homogenizer or a membrane homogenizer that contained gelled internal water droplets. Initially, we hypothesized that W/O/W emulsions containing gelled water droplets would be more stable than those containing nongelled water droplets. As to this particular study and conditions tested, the results indicate that there was some influence of the nature of the internal aqueous phase on the size of the W/O droplets produced in the W/O/W emulsions and/or on the stability of the internal water droplets during homogenization. However, another factor affecting the mean droplet size in the W/O/W emulsions was the type of homogenizer used to prepare them and the operating conditions. The high-pressure valve homogenizer was capable of producing smaller W/O droplets than the membrane homogenizer, but the particle size distribution was narrower for the membrane homogenizer. The mean W/O droplet size decreased as the number of passes through the membrane homogenizer increased or as the number of passes and homogenization pressure of the high-pressure valve homogenizer were increased. Further, in conjunction with such results, the long-term stability of the W/O/W emulsions may be improved by gelling the internal water phase (e.g., by inhibiting coalescence or Ostwald ripening of the internal water droplets).

We claim:

1. A multi-phase emulsion composition comprising a first aqueous phase comprising a biopolymeric component; a hydrophilic phase comprising a lipid component, said hydrophobic phase about said first aqueous phase; and a second aqueous phase about said hydrophobic phase, said biopolymeric component gelled within first aqueous phase.

2. The composition of claim 1 wherein said biopolymeric component is selected from a dairy protein.

3. The composition of claim 2 wherein said protein is a whey protein isolate.

4. The composition of claim 1 wherein said biopolymeric component is selected from a gum.

5. The composition of claim 1 wherein said lipid component is selected from an oil.

6. The composition of claim 1 wherein an emulsion of said first aqueous phase in said hydrophobic phase comprises a surface active agent at least partially soluble in said hydrophobic phase; and wherein an emulsion of said hydrophobic phase in said second aqueous phase comprises a surface active agent at least partially soluble in said second aqueous phase.

7. The composition of claim 1 incorporated into a processed food product, said emulsion comprising a food grade biopolymeric component and a food grade lipid component.

8. A water-in-oil-in-water emulsion composition comprising an emulsion of a first aqueous phase comprising a gelled biopolymeric component therein, in a hydrophobic phase comprising a lipid component; and an emulsion of said hydrophobic phase in a continuous second aqueous phase, said biopolymeric component comprising an irreversible gel matrix thereof.

9. The emulsion composition of claim 8 wherein said biopolymeric component is about 0.1 wt. % to about 20 wt. % of first aqueous phase.

10. The emulsion composition of claim 8 wherein said biopolymeric component is selected from globular proteins, said matrix comprising disulfide cross-linkages.

11. The emulsion composition of claim 10 wherein said matrix is the thermal gelation product of said globular protein in water.

12. The emulsion composition of claim 10 wherein said first aqueous phase comprises droplets dimensioned less than about 1 μm, and said hydrophobic phase in said second aqueous phase comprises droplets dimensioned less than about 5 μm.

13. An emulsion system comprising a continuous hydrophobic phase and a first aqueous phase therein, said first aqueous phase comprising a biopolymeric component; and at least one of a factor and a reagent at least partially sufficient to induce gelling of said biopolymeric component.

14. The emulsion system of claim 13 wherein said factor comprises heating said system

15. The emulsion system of claim 14 wherein said biopolymeric component is selected from globular proteins.

16. The emulsion system of claim 13 wherein said factor can be selected from a change in pH of said first aqueous phase and a change in ionic strength of said first aqueous phase.

17. The emulsion system of claim 14 wherein said reagent can comprise a metal ion.

18. The emulsion system of claim 17 wherein said biopolymeric component comprises an alginate.

19. The emulsion system of claim 13 wherein said system is an emulsion in a continuous second aqueous phase.

20. The emulsion system of claim 19 wherein said emulsion is incorporated into a processed food product, said emulsion comprising a food grade biopolymeric component and a food grade hydrophobic phase.

21. The method of using a biopolymer gelling component to affect mechanical stability of a water-in-oil-in-water emulsion, said method comprising:
providing a first aqueous phase component comprising a biopolymeric component;
emulsifying said first aqueous phase in a hydrophobic phase comprising a lipid component;
inducing at least partial gelation of said biopolymeric component within said first aqueous phase, said gelation at least partially sufficient to affect mechanical stability of said emulsion; and
emulsifying said first aqueous phase/hydrophobic phase emulsion within a second aqueous phase.

22. The method of claim 21 wherein said biopolymeric component is selected from a globular protein.

23. The method of claim 22 wherein said protein is thermally gelled.

24. The method of claim 21 wherein emulsification of said first aqueous phase comprises introduction of a surface active agent at least partially soluble in said hydrophobic phase; and wherein emulsification of said hydrophobic phase in said second aqueous phase comprises introduction of a surface active agent at least partially soluble in said second aqueous phase.

25. The method of claim 21 wherein said gelation is induced after said emulsification in said second aqueous phase.

26. The method of claim 21 wherein said emulsion is incorporated into a processed food product, said emulsion comprising a food grade biopolymeric component and a food grade hydrophobic phase.
